(19) United States
(12) Patent Application Publication
(10) Pub. No.: US 2026/0161023 A1
(43) Pub. Date: Jun. 11, 2026

(54) DISPLAY DEVICE

(71) Applicants: InnoLux Corporation, Miao-Li County (TW); CARUX TECHNOLOGY PTE. LTD., APERIA (SG)

(72) Inventors: Jyun-Sian LI, Miao-Li County (TW); Li-Wei SUNG, Tainan (Tainan Science Park) (TW); Hong-Sheng HSIEH, Miao-Li County (TW)

(21) Appl. No.: 19/388,016

(22) Filed: Nov. 13, 2025

(30) Foreign Application Priority Data
Dec. 10, 2024 (CN) 202411808467.9

(51) Int. Cl. G02F 1/13; G02F 1/1335; G02F 1/1337

(52) U.S. Cl. CPC G02F 1/1323; G02F 1/133528; G02F 1/133742

(57) ABSTRACT

A display device is provided. The display device includes a display panel, a first viewing angle control panel, and a second viewing angle control panel. The first viewing angle control panel overlaps the display panel and includes a first liquid-crystal layer. The second viewing angle control panel overlaps the display panel and the first viewing angle control panel and includes a second liquid-crystal layer. The first liquid-crystal layer is different from the second liquid-crystal layer, and the product of the first liquid-crystal birefringence value and the first liquid-crystal interlayer spacing is different from the product of the second liquid-crystal birefringence value and the second liquid-crystal interlayer spacing.

### CROSS REFERENCE TO RELATED APPLICATIONS

This application claims priority of China Patent Application No. 202411808467.9, filed on Dec. 10, 2024, the entirety of which is incorporated by reference herein.

### BACKGROUND

### Field of the Invention

The present disclosure relates to a display device, and, in particular, it relates to a display device that includes multiple viewing angle control panels with different liquid-crystal layers.

### Description of the Related Art

Due to the rapid development of science and technology, the use of electronic devices has become more and more popular nowadays, and display devices have gradually become popular among consumers. Currently, display devices need to have good anti-peeping functions based on security and privacy considerations. For example, when a display device is used in a vehicle-mounted device, if the display device was a good anti-peeping function, it can avoid distracting the driver, thereby improving road safety. Therefore, how to improve the anti-peeping performance of display devices is one of the most important issues.

### BRIEF SUMMARY

An embodiment of the present disclosure provides a display device, including a display panel, a first viewing angle control panel, and a second viewing angle control panel. The first viewing angle control panel overlaps the display panel and includes a first liquid-crystal layer. The first liquid-crystal layer has a first liquid-crystal birefringence value and a first liquid-crystal interlayer spacing. The second viewing angle control panel overlaps the display panel and the first viewing angle control panel and includes a second liquid-crystal layer. The second liquid-crystal layer has a second liquid-crystal birefringence value and a second liquid-crystal interlayer spacing. The first liquid-crystal layer is different from the second liquid-crystal layer, and the product of the first liquid-crystal birefringence value and the first liquid-crystal interlayer spacing is different from the product of the second liquid-crystal birefringence value and the second liquid-crystal interlayer spacing.

### BRIEF DESCRIPTION OF THE DRAWINGS

The present disclosure can be more fully understood by reading the subsequent detailed description and examples with references made to the accompanying drawings, wherein:

FIG. 1 shows a schematic view of a viewing angle control panel in accordance with some embodiments of the present disclosure;

FIG. 2 shows a schematic view of the viewing angle control panel in accordance with some embodiments of the present disclosure;

FIG. 3 shows a schematic view of the viewing angle control panel in accordance with some embodiments of the present disclosure;

FIG. 4 shows a diagram of the brightness and the viewing angle of the viewing angle control panel in accordance with some embodiments of the present disclosure;

FIGS. 5A through 5H show cross-sectional views of the display device in accordance with some embodiments of the present disclosure; and

FIG. 6 shows a cross-sectional view of the display device in accordance with some embodiments of the present disclosure.

### DETAILED DESCRIPTION

The present disclosure may be understood by referring to the following description and the appended drawings. It should be noted that, in order to make it easy for the reader to understand and to make the drawings concise, the drawings in the present disclosure may illustrate a part of the light-emitting unit, and specific elements in the drawings are not drawn based on the actual scale. In addition, the number and the size of each component in the drawings merely serves as an example, and are not intended to limit the scope of the present disclosure. Furthermore, similar and/or corresponding numerals may be used in different embodiments for describing some embodiments simply and clearly, but not represent any relationship between different embodiment and/or structures discussed below.

Certain terms may be used throughout the present disclosure and the appended claims to refer to particular elements. Those skilled in the art will understand that electronic device manufacturers may refer to the same components by different names. The present specification is not intended to distinguish between components that have the same function but different names. In the following specification and claims, the words “including”, “comprising”, “having” and the like are open words, so they should be interpreted as meaning “including but not limited to . . . ”. Therefore, when terms “including”, “comprising”, and/or “having” are used in the description of the disclosure, the presence of corresponding features, regions, steps, operations and/or components is specified without excluding the presence of one or more other features, regions, steps, operations and/or components.

In addition, in this specification, relative expressions may be used. For example, “lower”, “bottom”, “higher” or “top” are used to describe the position of one element relative to another. It should be noted that if a device is flipped upside down, an element that is “lower” will become an element that is “higher”.

When a corresponding component (such as a film layer or region) is referred to as “on another component”, it may be directly on another component, or there may be other components in between. On the other hand, when a component is referred “directly on another component”, there is no component between the former two. In addition, when a component is referred “on another component”, the two components have an up-down relationship in the top view, and this component can be above or below the other component, and this up-down relationship depends on the orientation of the device.

It should be understood that, although the terms “first”, “second” etc. may be used herein to describe various elements, layers and/or portions, and these elements, layers, and/or portions should not be limited by these terms. These terms are only used to distinguish one element, layer, or portion. Thus, a first element, layer or portion discussed below could be termed a second element, layer or portion without departing from the teachings of some embodiments of the present disclosure. In addition, for the sake of brevity, terms such as “first” and “second” may not be used in the description to distinguish different elements. As long as it does not depart from the scope defined by the appended claims, the first element and/or the second element described in the appended claims can be interpreted as any element that meets the description in the specification.

In the present disclosure, lengths, widths, or heights can be measured using an optical microscope, or measured from a cross-sectional image in an electron microscope. However, the above measurement serves as an example, and not limited thereto. In addition, a certain error may be present in a comparison with any two values or directions. The terms “about,” “equal to,” “equivalent,” “the same,” “essentially” or “substantially” are generally interpreted as within 10% of a given value or range, or as interpreted as within 5%, 3%, 2%, 1%, or 0.5% of a given value or range. It should be understood that if the present disclosure recites “the first element is electrically connected to the second element,” it may be interpreted as that the first element and the second element are directly electrically connected to each other, or there may be other elements between the first element and the second element to electrically connect the former two.

It should be noted that the technical solutions provided by different embodiments below may be interchangeable, combined or mixed to form another embodiment without departing from the spirit of the present disclosure.

Unless defined otherwise, all terms (including technical and scientific terms) used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined in the present disclosure.

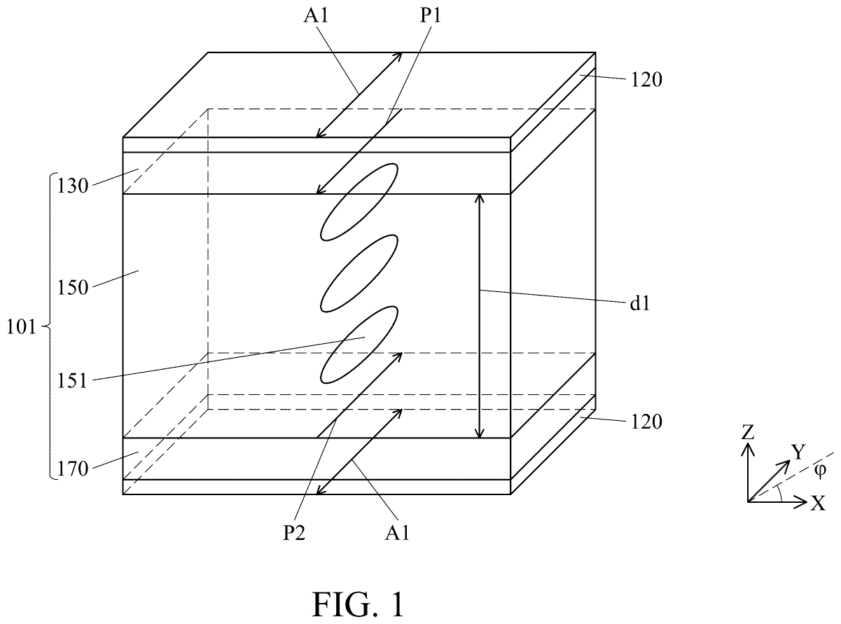

FIG. 1 shows a schematic view of a viewing angle control panel 101 in accordance with some embodiments of the present disclosure. The viewing angle control panel 101 may be disposed on the following component, such as a display device, a backlight device, an antenna device, a light-emitting device, a sensing device, a touch device, or a splicing device, but not limited thereto. The display device may be a bendable or flexible display device. The display device may be a non-self-luminous display device or a self-luminous display device. In some embodiments, the display device includes a flexible panel. The flexible panel includes electronic components. The electronic components may include passive components and active components, such as capacitors, resistors, inductors, diodes, transistors, etc. In some embodiments, the electronic device may include a diode, a liquid crystal, a light-emitting diode (LED), a quantum dot (QD), fluorescence, phosphor, other suitable display media, or a combination thereof. In some embodiments, the diode may include a light-emitting diode or a photodiode. The light-emitting diode may include an organic light-emitting diode (OLED), a mini light-emitting diode (mini LED), a micro LED, or a quantum dot light-emitting diode (quantum dot LED), but not limited thereto. The splicing device may be a display splicing device or an antenna splicing device, but not limited thereto. It should be noted that the display device

As shown in FIG. 1, the viewing angle control panel 101 may include a substrate 130, a substrate 170, and a liquid-crystal layer 150 disposed between the substrates 130 and 170. The viewing angle control panel 101 may be an electrically controlled birefringence (ECB) viewing angle control panel, but not limited thereto. In some embodiments, the substrate 130 may be opposite to the substrate 170, and the substrates 130 and 170 are located between opposite polarizing plates 120. The substrates 130 and 170 may include glass, polymer materials (such as polyethylene terephthalate (PET), polycarbonate (PC), triacetyl cellulose (TAC), polyimide (PI), etc.), ceramics or other suitable light-transmitting materials, but not limited thereto. In some embodiments, the thicknesses of substrate 130 and substrate 170 may be the same as or different from each other.

In some embodiments, the liquid-crystal layer 150 is disposed between the substrates 130 and 170. In some embodiments, the liquid-crystal layer 150 includes a plurality of liquid-crystal molecules 151. It should be noted that for the purpose of illustration, the liquid-crystal molecules 151 in the liquid-crystal layer 150 are enlarged, instead of indicating the actual size of the liquid-crystal molecules 151. The liquid-crystal layer 150 may include cholesteric liquid-crystal (CLC), polymer-stabilized cholesteric liquid-crystal (PSCT), or other dispersed liquid crystals, but not limited thereto. In some embodiments, a sealant (not shown) may be disposed between the substrates 130 and 170. The sealant may surround the liquid-crystal layer 150, thereby sealing the liquid-crystal layer 150 in the space formed by the substrate 130, the substrate 170 and the sealant. The angular axial relationship of each element will be further described below. It should be understood that for ease of description, the angle φ is defined in the present disclosure as 0 degrees in the +X axis direction, 90 degrees in the +Y axis direction, and so on. However, the angle φ is merely used to indicate the relative relationship between the components, and does not represent the coordinate directions in which the components are actually disposed.

In some embodiments, at least one polarizing plate 120 is disposed on at least one side of the viewing angle control panel 101. Referring to FIG. 1, two polarizing plates 120 are respectively disposed on opposite sides of the viewing angle control panel 101. The polarizing plate 120 may have a transmission axis A1, and the transmission axis A1 is substantially parallel to the Y-axis direction. Specifically, the transmission axis A1 may have an angle φ between 80 degrees and 100 degrees (e.g., approximately 90 degrees). In some embodiments, the alignment layer (not shown) on the substrate 130 has an alignment direction P1, and the alignment layer (not shown) on the substrate 170 has an alignment direction P2. In some embodiments, the alignment direction P1 and the alignment direction P2 are substantially opposite and substantially parallel to the transmission axis A1. In the embodiment, the alignment direction P1 may have an angle φ between 255 degrees and 285 degrees (e.g., approximately 270 degrees), and the alignment direction P2 may have an angle q between 75 degrees and 105 degrees (e.g., approximately 90 degrees). In some embodiments, the angle difference between the alignment directions P1 and P2 is between 170 degrees and 190 degrees (e.g., about 180 degrees). As a result, in the initial state (such as the power-off state), the liquid-crystal molecules 151 of the liquid-crystal layer 150 disposed between the substrates 130 and 170 can be arranged substantially along the angles of the alignment directions P1 and P2. The liquid-crystal molecules 151 may have a macro-axis substantially parallel to the alignment directions P1 and P2. In the present embodiment, the liquid-crystal molecules 151 are horizontally aligned (e.g., the macro-axis of the liquid-crystal molecules 151 is parallel to the X-Y plane) when no voltage is applied, but not limited thereto. In some embodiments, the liquid-crystal molecules 151 may be in a hybrid alignment without applying a voltage. When no voltage is applied, the liquid-crystal molecules 151 adjacent to the substrate 130 and the liquid-crystal molecules 151 adjacent to the substrate 170 are horizontally aligned and vertically aligned, respectively. In some embodiments, the viewing angle control panel 101 may include a control electrode (not individually shown) disposed on one or both of the substrates 130 and 170. In some embodiments, the control electrode may be distributed throughout the substrate 130 or the substrate 170, or may be a plurality of mutually parallel patterns disposed on the substrate 130 or the substrate 170. The control electrode may include metal or other suitable conductive materials (such as indium tin oxide (ITO), chromium (Cr), indium zinc oxide (IZO), etc.), but not limited thereto. In some embodiments, the control electrode may be selectively electrically connected or not electrically connected to a power source (not shown). When the control electrodes of substrate 130 and substrate 170 are electrically connected to a power source (that is, in the power-on state), there may be a potential difference between the control electrodes of substrate 130 and substrate 170 to form a vertical electric field, thereby controlling the arrangement of the liquid-crystal layer 150. Specifically, when voltage is applied to the control electrodes of substrates 130 and 170, the liquid-crystal molecules 151 of the liquid-crystal layer 150 can be rotated, thereby switching the viewing angle control panel 101 between the general display mode and the anti-peeping mode, so as to achieve the anti-peeping effect on the left and right sides of the macro-axis of the liquid-crystal molecules 151.

In some embodiments, the liquid-crystal layer 150 has a liquid-crystal birefringence value (Δn) and a liquid-crystal interlayer spacing d1. The liquid-crystal interlayer spacing d1 may be defined as the thickness of the liquid-crystal layer 150 between the substrates 130 and 170 in the normal direction (e.g., the Z-axis direction) of the substrate 130 (or the substrate 170), but not limited thereto. In some embodiments, the liquid-crystal interlayer spacing d1 may be between about 2 μm and about 6.5 μm. In some embodiments, the product of the liquid-crystal birefringence value of the liquid-crystal layer 150 and the liquid-crystal interlayer spacing d1 may be between about 400 nm and about 1300 nm. By adjusting the product of the liquid-crystal birefringence value of the liquid-crystal layer 150 and the liquid-crystal interlayer spacing d1, the anti-peeping effect of the viewing angle control panel 101 at different viewing angles can be tuned. For example, if the product of the liquid-crystal birefringence value of the liquid-crystal layer 150 and the liquid-crystal interlayer spacing d1 increases, the anti-peeping area of the viewing angle control panel 101 can be closer to a small viewing angle (that is, a position with a relatively small angle (e.g., less than 40 degrees) from the normal direction (e.g., the Z-axis direction) of the substrate 130 (or the substrate 170)). In some embodiments, a compensation film (not shown) may be selectively disposed between the viewing angle control panel 101 and the polarizing plate 120 to enhance the anti-peeping effect of the viewing angle control panel 101 in a direction deviating from the macro-axis of the liquid-crystal molecules 151.

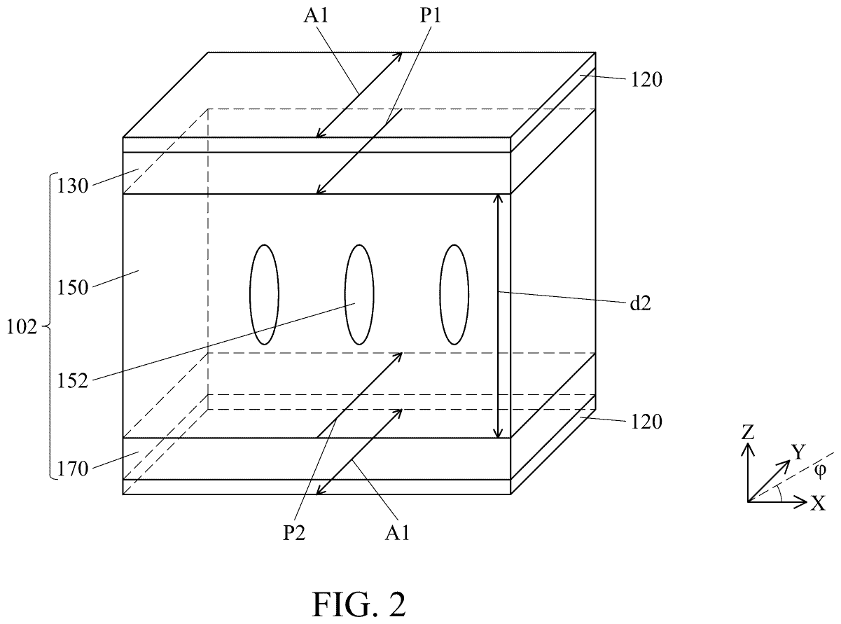

FIG. 2 shows a schematic view of a viewing angle control panel 102 in accordance with some embodiments of the present disclosure. It should be understood that the viewing angle control panel 102 shown in this embodiment may include elements that are the same as or similar to those of the viewing angle control panel 101 shown in FIG. 1, and these elements will be denoted by the same or similar reference numerals. As shown in FIG. 2, the viewing angle control panel 102 includes a substrate 130, a substrate 170, and a liquid-crystal layer 150 disposed between the substrates 130 and 170. The viewing angle control panel 102 may be a vertical alignment (VA) viewing angle control panel, but not limited thereto. Similarly, the polarizing plate 120 may have a transmission axis A1, and the transmission axis A1 is substantially parallel to the Y-axis direction. Specifically, the transmission axis A1 may have an angle q between 80 degrees and 100 degrees (e.g., approximately 90 degrees). In some embodiments, the alignment layer (not shown) on the substrate 130 has an alignment direction P1, and the alignment layer (not shown) on the substrate 170 has an alignment direction P2. In some embodiments, the alignment direction P1 and the alignment direction P2 are substantially opposite and substantially parallel to the transmission axis A1. In the present embodiment, the alignment direction PI may have an angle φ between 245 degrees and 295 degrees (e.g., approximately 270 degrees), and the alignment direction P2 may have an angle φ between 65 degrees and 115 degrees (e.g., approximately 90 degrees). In some embodiments, the angle difference between the alignment directions P1 and P2 of the substrates 130 and 170 is between 170 degrees and 190 degrees (e.g., about 180 degrees).

In some embodiments, the liquid-crystal layer 150 includes a plurality of liquid-crystal molecules 152. The liquid-crystal molecules 152 of the liquid-crystal layer 150 disposed between the substrates 130 and 170 may be arranged substantially along the angles of the alignment directions P1 and P2. The liquid-crystal molecules 152 may have a macro-axis that is substantially parallel to the normal direction of the substrates 130 and 170 and substantially perpendicular to the alignment directions P1 and P2. In this embodiment, the liquid-crystal molecules 152 are vertically aligned when no voltage is applied, but not limited thereto. In some embodiments, the liquid-crystal molecules 152 may be in a hybrid alignment without applying any voltage. When no voltage is applied, the liquid-crystal molecules 152 adjacent to the substrate 130 and the liquid-crystal molecules 152 adjacent to the substrate 170 are horizontally aligned and vertically aligned, respectively.

In some embodiments, the substrates 130 and 170 may each have control electrodes (not individually shown). When the control electrodes of the substrates 130 and 170 are electrically connected to a power source (that is, in the power-on state), a potential difference may exist between the control electrodes of the substrates 130 and 170 to form a vertical electric field, thereby controlling the arrangement of the liquid-crystal layer 150. Specifically, when a voltage is applied to the control electrodes of the substrates 130 and 170, the liquid-crystal molecules 152 of the liquid-crystal layer 150 can be rotated, thereby achieving the anti-peeping effect on the left and right sides of the macro-axis of the liquid-crystal molecules 152.

In some embodiments, the liquid-crystal layer 150 has a liquid-crystal birefringence value (Δn) and a liquid-crystal interlayer spacing d2. The liquid-crystal interlayer spacing d2 may be defined as the thickness of the liquid-crystal layer 150 between the substrates 130 and 170 in the normal direction (e.g., the Z-axis direction) of the substrate 130 (or the substrate 170), but not limited thereto. In some embodiments, the liquid-crystal interlayer spacing d2 may be between about 2 μm and about 6.5 μm. In some embodiments, the product of the liquid-crystal birefringence value of the liquid-crystal layer 150 and the liquid-crystal interlayer spacing d2 may be between about 400 nm and about 1300 nm. By adjusting the product of the liquid-crystal birefringence value of the liquid-crystal layer 150 and the liquid-crystal interlayer spacing d2, the anti-peeping effect of the viewing angle control panel 102 at different viewing angles can be tuned. For example, if the product of the liquid-crystal birefringence value of the liquid-crystal layer 150 and the liquid-crystal interlayer spacing d2 increases, the anti-peeping area of the viewing angle control panel 102 can be closer to a small viewing angle (i.e., a position with a relatively small angle (e.g., less than 40 degrees) from the normal direction (e.g., the Z-axis direction) of the substrate 130 (or substrate 170)). In some embodiments, a compensation film (not shown) may be selectively disposed between the viewing angle control panel 102 and the polarizing plate 120 to enhance the anti-peeping effect of the viewing angle control panel 102 in a direction deviating from the macro-axis of the liquid-crystal molecules 152.

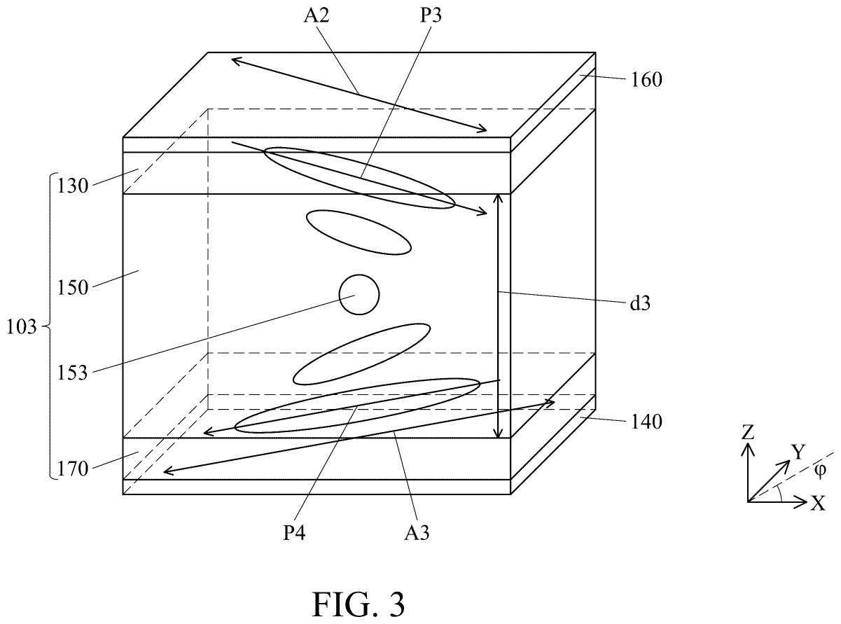

FIG. 3 shows a schematic view of a viewing angle control panel 103 in accordance with some embodiments of the present disclosure. It should be understood that the viewing angle control panel 103 shown in this embodiment may include elements that are the same as or similar to those of the viewing angle control panel 101 shown in FIG. 1, and these elements will be denoted by the same or similar reference numerals. As shown in FIG. 3, the viewing angle control panel 103 includes a substrate 130, a substrate 170, and a liquid-crystal layer 150 disposed between the substrates 130 and 170. The viewing angle control panel 103 may be a twisted nematic (TN) viewing angle control panel, but not limited thereto. In some embodiments, the polarizing plate 160 is disposed on one side of the substrate 130 away from the liquid-crystal layer 150, and the polarizing plate 140 is disposed on one side of the substrate 170 away from the liquid-crystal layer 150. Specifically, the polarizing plate 160 may have a transmission axis A2, and the polarizing plate 140 may have a transmission axis A3, and the transmission axes A2 and A3 are substantially perpendicular to each other and located between the X-axis and the Y-axis directions. Specifically, the penetration axis A2 may have an angle φ between 125 degrees and 145 degrees (e.g., approximately 135 degrees), and the penetration axis A3 may have an angle φ between 35 degrees and 55 degrees (e.g., approximately 45 degrees). In other embodiments, the polarizing plate 120 and the polarizing plate 180 may replace the polarizing plate 140 and the polarizing plate 160, respectively, wherein either of the transmission axis of the polarizing plate 120 and the transmission axis of the polarizing plate 180 is substantially parallel to the X-axis direction and the other is substantially parallel to the Y-axis direction, but not limited thereto.

In some embodiments, the alignment layer (not shown) on the substrate 130 has an alignment direction P3, and the alignment layer (not shown) on the substrate 170 has an alignment direction P4. In some embodiments, the alignment direction P3 is substantially parallel to the penetration axis A2, the alignment direction P4 is substantially parallel to the penetration axis A3, and the alignment direction P3 and the alignment direction P4 are substantially perpendicular to each other. The alignment direction P3 may have an angle q between 305 degrees and 325 degrees (e.g., about 315 degrees, which can also be regarded as −45 degrees for ease of understanding), and the alignment direction P4 may have an angle φ between about 215 degrees and about 235 degrees (e.g., about 225 degrees), but not limited thereto. In some embodiments, either of the alignment directions P3 and the alignment direction P4 may be approximately 0 degrees or approximately 90 degrees, but not limited thereto. In some embodiments, the angle difference between the alignment directions P3 and P4 of the substrate 130 and the substrate 170 is between 80 degrees and 100 degrees (e.g., about 90 degrees).

In some embodiments, the liquid-crystal layer 150 includes a plurality of liquid-crystal molecules 153. The liquid-crystal molecule 153 may have a macro-axis. The liquid-crystal molecules 153 of the liquid-crystal layer 150 disposed adjacent to the substrate 130 can be arranged approximately along the angle of the alignment direction P3 (i.e., their macro-axis is approximately parallel to the alignment direction P3), the liquid-crystal molecules 153 of the liquid-crystal layer 150 disposed adjacent to the substrate 170 can be arranged approximately along the angle of the alignment direction P4 (i.e., their macro-axis is approximately parallel to the alignment direction P4), and the macro-axes of the remaining liquid-crystal molecules 153 are located between the alignment direction P3 and the alignment direction P4 and gradually rotate.

In some embodiments, the substrates 130 and 170 may each have control electrodes (not individually shown). When the control electrodes of the substrates 130 and 170 are electrically connected to a power source (that is, in the power-on state), a potential difference may exist between the control electrodes of the substrates 130 and 170 to form a vertical electric field, thereby controlling the arrangement of the liquid-crystal layer 150. Specifically, when a voltage is applied to the control electrodes of the substrates 130 and 170, the liquid-crystal molecules 153 of the liquid-crystal layer 150 can be rotated, thereby achieving an anti-peeping effect. In some embodiments, if the liquid-crystal molecules 153 are applied to a left-hand drive vehicle-mounted device, the alignment direction P3 of the liquid-crystal molecules 153 adjacent to the substrate 130 minus 180 degrees is 135 degrees, and the alignment direction P4 of the liquid-crystal molecules 153 adjacent to the substrate 170 is 225 degrees (in other embodiments, the alignment direction P3 minus 180 degrees may also be 225 degrees, and the alignment direction P4 may be 135 degrees). On the contrary, if the liquid-crystal molecules 153 are applied to a right-hand drive vehicle-mounted device, the alignment direction P3 of the liquid-crystal molecules 153 adjacent to the substrate 130 minus 180 degrees is-45 degrees, and the alignment direction P4 of the liquid-crystal molecules 153 adjacent to the substrate 170 is 45 degrees (in other embodiments, the alignment direction P3 minus 180 degrees may also be 45 degrees, and the alignment direction P4 may be −45 degrees).

In some embodiments, the liquid-crystal layer 150 has a liquid-crystal birefringence value (Δn) and a liquid-crystal interlayer spacing d3. The liquid-crystal interlayer spacing d3 may be defined as the thickness of the liquid-crystal layer 150 between the substrates 130 and 170 in the normal direction (e.g., the Z-axis direction) of the substrate 130 (or the substrate 170), but not limited thereto. In some embodiments, the liquid-crystal interlayer spacing d3 may be between 4 μm and 15 μm. In some embodiments, the product of the liquid-crystal birefringence value of the liquid-crystal layer 150 and the liquid-crystal interlayer spacing d3 may be between about 800 nm and about 3000 nm. However, not limited thereto. By adjusting the product of the liquid-crystal birefringence value of the liquid-crystal layer 150 and the liquid-crystal layer interval d3, the anti-peeping effect of the viewing angle control panel 103 at different viewing angles can be tuned. For example, if the product of the liquid-crystal birefringence value of the liquid-crystal layer 150 and the liquid-crystal interlayer spacing d3 increases, the anti-peeping area of the viewing angle control panel 103 can be closer to a small viewing angle (i.e., a position with a relatively small angle (e.g., less than 40 degrees) from the normal direction (e.g., the Z-axis direction) of the substrate 130 (or substrate 170)). In some embodiments, a compensation film (not shown) may be selectively disposed between the viewing angle control panel 103 and the polarizing plate 140 and/or between the viewing angle control panel 103 and the polarizing plate 160 to increase the anti-peeping effect of the liquid-crystal molecules 153 deviating from the direction of the liquid-crystal rotation.

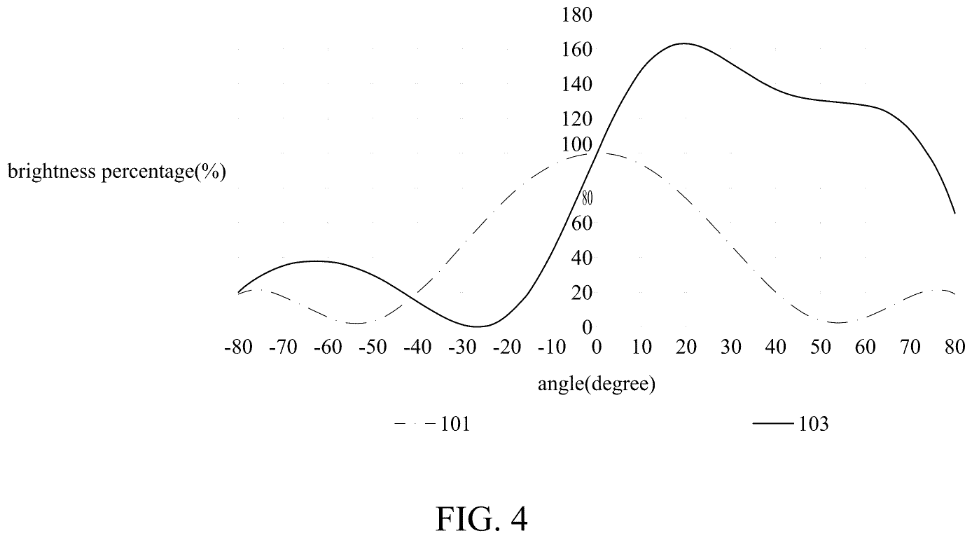

FIG. 4 shows a diagram of the brightness percentage and the observation angle (or referred to as viewing angle) of the viewing angle control panels 101 and 103 in accordance with some embodiments of the present disclosure. It should be noted that the viewing angle can be defined as the angle between the user's viewing direction and the normal direction of the display device. When the user views from the normal direction of the display device, the viewing angle is 0 degrees, which is the front viewing angle. The brightness percentage can be calculated by dividing the brightness at the viewing angle by the brightness at the front viewing angle and multiplying it by 100%. As shown in FIG. 4, the product of the liquid-crystal birefringence value and the liquid-crystal interlayer spacing of the viewing angle control panel 101 is approximately 700 nm, and the product of the liquid-crystal birefringence value and the liquid-crystal interlayer spacing of the viewing angle control panel 103 is approximately 1100 nm. Since the liquid-crystal layers of the viewing angle control panels 101 and 103 are different, their anti-peeping capabilities are also different. The viewing angle control panel 101 has a better anti-peeping effect at a large viewing angle (i.e., an angle close to the normal direction of the display device, and the angle between the viewing direction and the normal direction of the display device is greater than 40 degrees), while the viewing angle control panel 103 has a better anti-peeping effect at a small viewing angle (i.e., an angle away from the normal direction of the display device, and the angle between the viewing direction and the normal direction of the display device is less than 40 degrees). Therefore, if the viewing angle control panels 101 and 103 are simultaneously adopted in the display device, a good anti-peeping effect can be achieved in a wider viewing angle range.

In some embodiments, at least one viewing angle control panel 101 and at least one viewing angle control panel 103 are stacked to form a display device. Two viewing angle control panels 101 and one viewing angle control panel 103 may be stacked to form a display device. In some embodiments, one viewing angle control panel 101 and two viewing angle control panels 103 are stacked to form a display device. With this design, when the viewing angle (the angle between the user's viewing direction and the normal direction of the display device) is between 31 degrees and 65 degrees, the ratio of the brightness of the side viewing angle to the brightness of the front viewing angle of the display device can be less than 1%. For example, at a viewing angle of 31 degrees, the brightness of the display device may be less than 1% (e.g., less than 0.8%); at a viewing angle of 38 degrees and 65 degrees, the brightness of the display device may be less than 0.5% (e.g., less than 0.4%); at a viewing angle of 45 degrees, the brightness of the display device may be less than 0.4% (e.g., less than 0.3%), but not limited thereto. As described above, the display device combining the viewing angle control panels 101 and 103 can achieve good anti-peeping effect in a wider viewing angle range.

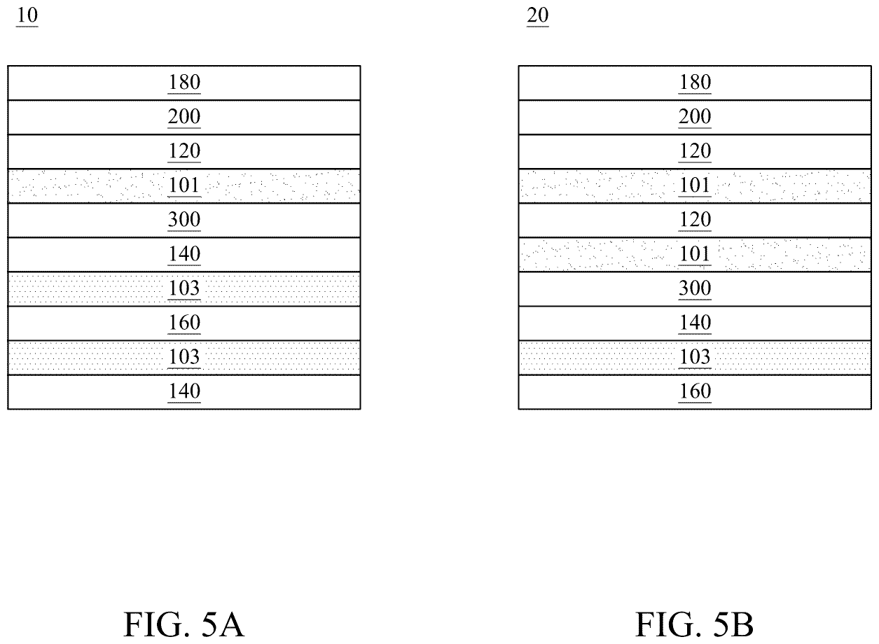

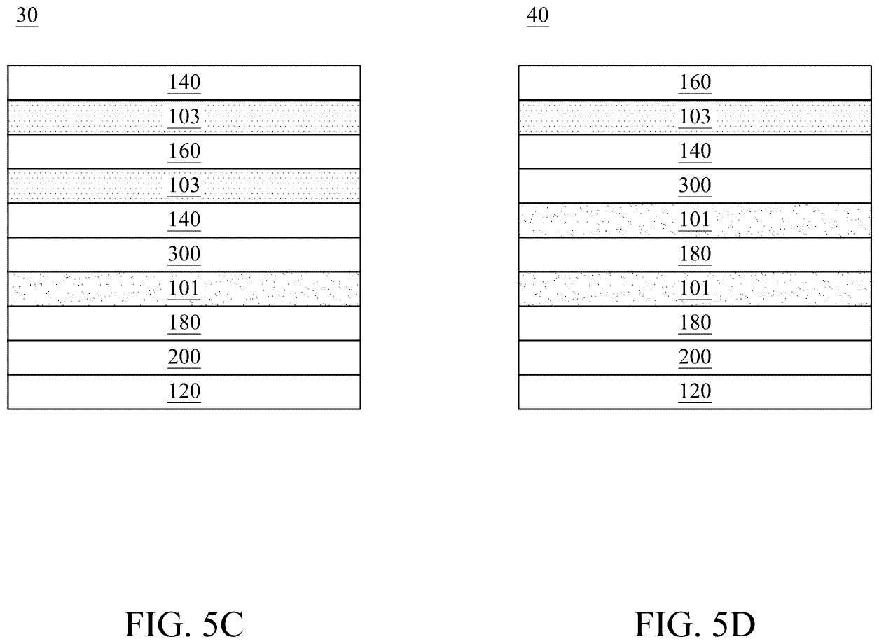

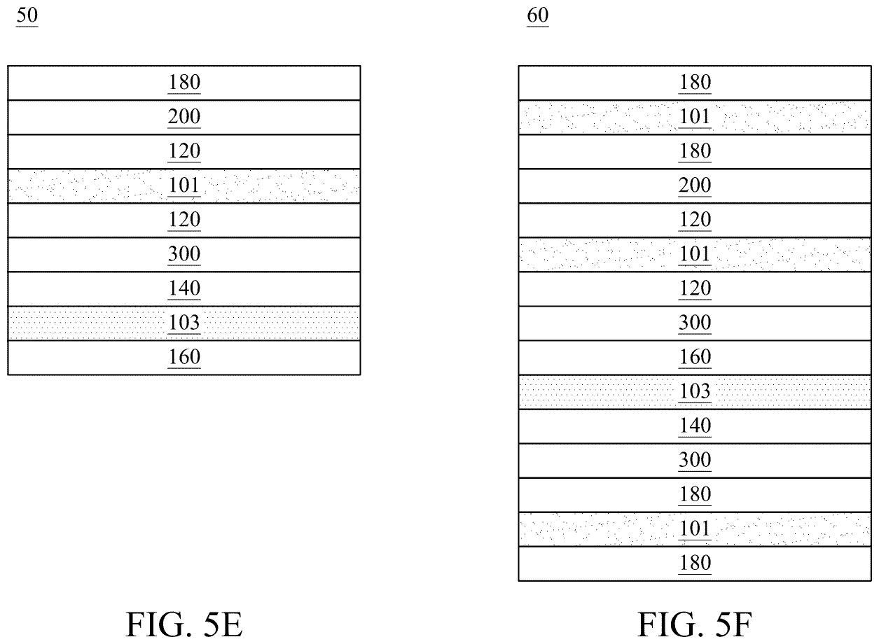

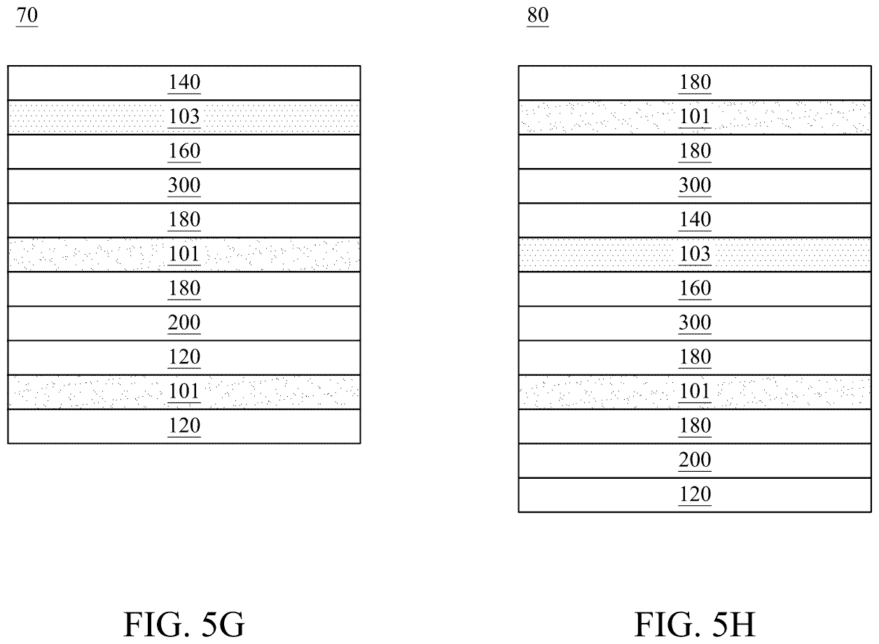

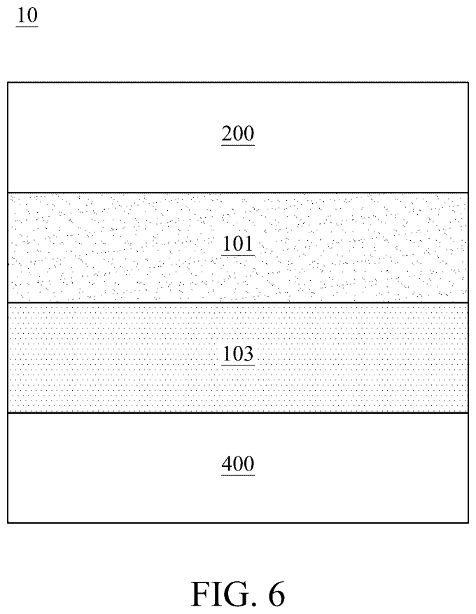

FIGS. 5A through 5H shows cross-sectional schematic views of the display devices in accordance with some embodiments of the present disclosure. As shown in FIG. 5A, the display device 10 includes a display panel 200, a viewing angle control panel 101, viewing angle control panels 103, and a half-wave plate 300. It should be understood that the display panel 200 in FIGS. 5A to 5H may be a non-self-luminous panel or a self-luminous panel. If the display panel 200 is a non-self-luminous panel, the display device 10 may further include a backlight module (such as the backlight module 400 shown in FIG. 6) so that the display panel 200 can display images to the users. In this embodiment, the display device 10 includes two viewing angle control panels 103, and polarizing plates 140 and 160 may be disposed on opposite sides of the viewing angle control panels 103, and the transmission axes of the polarizing plates 140 and 160 are substantially perpendicular to each other. The polarizing plate 140 has a transmission axis with an angle between 35 degrees and 55 degrees (e.g., about 45 degrees), and the polarizing plate 160 has a transmission axis with an angle between 125 degrees and 145 degrees (e.g., about 135 degrees), but not limited thereto.

In addition, the half-wave plate 300 may be selectively disposed between the viewing angle control panels 101 and 103 to enhance the display effect of the display device 10. Specifically, the polarizing plate 140 is disposed between the viewing angle control panel 103 and the half-wave plate 300, and the half-wave plate 300 is disposed between the polarizing plate 140 and the viewing angle control panel 101. In some embodiments, referring to Table 1, the angle of the slow axis of the half-wave plate 300 may be, e.g., approximately 67.5 degrees or approximately 157.5 degrees. In some embodiments, the viewing angle control panel 101 is disposed between the polarizing plate 120 (which has a transmission axis of about 90 degrees) and the half-wave plate 300. In some embodiments, the angle difference between the transmission axes of the polarizing plates 140 and 120 is between 35 degrees and 55 degrees (e.g., about 45 degrees). In some embodiments, the polarizing plate 120 may be selectively disposed between the viewing angle control panel 101 and the half-wave plate 300, but not limited thereto. The display panel 200 is disposed on the polarizing plate 120 and located between the polarizing plates 120 and 180 (which has a transmission axis of about 0 degree), and the transmission axis of the polarizing plate 180 is substantially perpendicular to the transmission axis of the polarizing plate 120. The angle difference between the transmission axes of the polarizing plates 180 and 120 is between 80 degrees and 100 degrees (e.g., about 90 degrees). In some embodiments, the transmission axes of the two polarizing plates located on the upper and lower sides of the display panel 200 or the viewing angle control panel 103 are substantially perpendicular to each other, and the transmission axes of the two polarizing plates located on the upper and lower sides of the viewing angle control panel 101 are substantially parallel to each other.

In the present embodiment, when the alignment direction P3 and the alignment direction P4 of the viewing angle control panels 103 are approximately 90 degrees and approximately 0 degree, respectively. The polarizing plates 120 and 180 may be disposed on opposite sides of the viewing angle control panel 103, wherein the transmission axis of the polarizing plate 120 is between 80 degrees and 100 degrees (e.g., approximately 90 degrees), and the transmission axis of the polarizing plate 180 is between-10 degrees and 10 degrees (e.g., approximately 0 degrees). It should be understood that the alignment directions of the viewing angle control panels 103 and the corresponding arrangement of the polarizing plates 120 and 180 can be adopted in all embodiments of the present disclosure.

In some embodiments, any two adjacent panels (e.g., between the display panel and the viewing angle control panel, or between two viewing angle control panels) may share a polarizing plate, a half-wave plate, or both. The display panel 200 is disposed adjacent to the viewing angle control panel 101, wherein the polarizing plate 120 can be disposed between the display panel 200 and the viewing angle control panel 101 as a common polarizing plate for the display panel 200 and the viewing angle control panel 101, thereby reducing the manufacturing cost and simplifying the manufacturing process of the display device 10. In some embodiments, the half-wave plate 300 may be selectively disposed between different types of viewing angle control panels 101 and 103, thereby increasing light transmittance and improving the display effect of the display device 10. As described above, the polarizing plate is disposed between different types of viewing angle control panels 101 and viewing angle control panels 103. Furthermore, the half-wave plate 300 (as shown in FIG. 5E) may be selectively disposed between the polarizing plate adjacent to the viewing angle control panel 101 and the polarizing plate adjacent to the viewing angle control panel 103. The half-wave plate 300 can rotate the polarization direction of light, so the polarizing plate between the half-wave plate 300 and the viewing angle control panel 101 or between the half-wave plate 300 and the viewing angle control panel 103 can be omitted by setting an appropriate slow axis angle. Taking FIG. 5A as an example, the polarizing plate 120 is omitted between the viewing angle control panel 101 and the half-wave plate 300, but not limited thereto. In some embodiments, the display panel 200 is disposed between the viewing angle control panel 101 and the viewing angle control panel 103, wherein the half-wave plate 300 may be selectively disposed between the polarizing plate adjacent to the display panel 200 and the polarizing plate adjacent to the viewing angle control panel 103. The half-wave plate 300 can rotate the polarization direction of light, so the polarizing plate between the half-wave plate 300 and the display panel 200 or between the half-wave plate 300 and the viewing angle control panel 103 can be omitted by setting an appropriate slow axis angle. The description of this paragraph may be applicable to all embodiments of the present disclosure and will not be repeated below.

It should be understood that the display device in the embodiments shown in the following FIGS. 5B through 5H may include elements the same as or similar to those of the display device 10 shown in FIG. 5A. These elements will be denoted by the same or similar reference numerals and will not be described in detail below.

As shown in FIG. 5B, the display device 20 includes a display panel 200, viewing angle control panels 101, a viewing angle control panel 103, and an optional half-wave plate 300. It should be understood that, in this embodiment, the display device 20 includes two viewing angle control panels 101, and the polarizing plates 120 may be disposed on opposite sides of the viewing angle control panels 101. The polarizing plates 140 and 160 may be disposed on opposite sides of the viewing angle control panel 103, and the transmission axes of the polarizing plates 140 and 160 are substantially perpendicular to each other.

In addition, the half-wave plate 300 may be selectively disposed between the viewing angle control panel 101 and the viewing angle control panel 103 to improve the display effect of the display device 20. In some embodiments, referring to Table 1, the angle of the slow axis of the half-wave plate 300 may be, for example, approximately 67.5 degrees or approximately 157.5 degrees. In some embodiments, the polarizing plate 120 may be selectively disposed between the viewing angle control panel 101 and the half-wave plate 300, but not limited thereto. The display panel 200 is disposed on the polarizing plate 120 and located between the polarizing plates 120 and 180, and the transmission axis of the polarizing plate 180 is substantially perpendicular to the transmission axis of the polarizing plate 120. Table 1 and Table 2 are used as examples below to illustrate the angle of the slow axis of the half-wave plate 300 at different incident polarization angles and/or output polarization angles, but not limited thereto. In the present disclosure, the angle of the slow axis of the half-wave plate 300 may be greater than or equal to 0 degrees and less than 180 degrees. The angle of the slow axis of the half-wave plate 300 can be adjusted as required to control the light transmittance of the half-wave plate 300, and any possible configuration of the half-wave plate 300 is within the scope of the present disclosure.

TABLE 1

output polarization angles

| incident polarization angles | 0 degree | 90 degrees |
|---|---|---|
| 135 degrees | 67.5 degrees | 22.5 degrees |
| | or | or |
| | 157.5 degrees | 112.5 degrees |
| 45 degrees | 22.5 degrees | 67.5 degrees |
| | or | or |
| | 112.5 degrees | 157.5 degrees |

TABLE 2

output polarization angles

| incident polarization angles | 135 degrees | 45 degrees |
|---|---|---|
| 0 degree | 67.5 degrees | 22.5 degrees |
| | or | or |
| | 157.5 degrees | 112.5 degrees |
| 90 degrees | 22.5 degrees | 67.5 degrees |
| | or | or |
| | 112.5 degrees | 157.5degrees |

It should be understood that the polarization angle can be determined by the transmission axis angle of the polarizing plate, but not limited thereto. In FIG. 5B, the polarizing plates adjacent to the opposite sides of the half-wave plate 300 are the polarizing plates 140 and 120, respectively. The light is incident to the half-wave plate 300 from the polarizing plate 140 and then emitted from the half-wave plate 300 to the polarizing plate 120, wherein the transmission axis of the polarizing plate 140 may be approximately 45 degrees, and the transmission axis of the polarizing plate 120 may be approximately 90 degrees. Now, the column in Table 1 where the incident polarization angle is 45 degrees and the outgoing polarization angle is 90 degrees can be referred to. The above-mentioned configuration of the angles of the slow axis of the half-wave plate 300 can effectively improve light transmittance, but the configurations in Table 1 and Table 2 are provided for corresponding angles of preferred examples and are not intended to limit the scope of the present disclosure.

In addition, as shown in FIG. 5C, the display device 30 includes a display panel 200, a viewing angle control panel 101, viewing angle control panels 103, and an optional half-wave plate 300. It should be understood that in this embodiment, one viewing angle control panel 101 and two viewing angle control panels 103 are disposed above the display panel 200, and the half-wave plate 300 may be selectively disposed between the viewing angle control panels 101 and 103 to enhance the display effect of the display device 30. In this embodiment, the viewing angle control panel 103 is disposed between the polarizing plates 160 and 140. As described above, the transmission axes of the polarizing plates 140 and 160 are substantially perpendicular to each other. In some embodiments, referring to Table 2, the angle of the slow axis of the half-wave plate 300 may be approximately 22.5 or approximately 112.5 degrees. In some embodiments, the polarizing plate 180 may be selectively disposed between the viewing angle control panel 101 and the half-wave plate 300, but not limited thereto. For example, if the polarizing plate 120 or the polarizing plate 180 is adjacent to the polarizing plate 140 or the polarizing plate 160, the half-wave plate 300 may be inserted between the above polarizing plates to improve light transmittance. In the embodiment where the half-wave plate 300 is disposed between the polarizing plates, either of the polarizing plates may be omitted according to the placement angle of the half-wave plate 300. It should be understood that the above-mentioned configuration of the half-wave plate 300 is applicable to all embodiments of the present disclosure.

In addition, as shown in FIG. 5D, the display device 40 includes a display panel 200, viewing angle control panels 101, a viewing angle control panel 103, and an optional half-wave plate 300. It should be understood that in this embodiment, two viewing angle control panels 101 and one viewing angle control panel 103 are disposed above the display panel 200, and the half-wave plate 300 can be selectively disposed between the viewing angle control panels 101 and 103 to enhance the display effect of the display device 40. In some embodiments, referring to Table 2, the angle of the slow axis of the half-wave plate 300 may be approximately 22.5 or approximately 112.5 degrees. In some embodiments, the polarizing plate 180 may be selectively disposed between the viewing angle control panel 101 and the half-wave plate 300, but not limited thereto.

As shown in FIG. 5E, the display device 50 includes a display panel 200, a viewing angle control panel 101, a viewing angle control panel 103, and an optional half-wave plate 300. In some embodiments, the polarizing plates 120 and 180 are respectively disposed on two opposite sides of the display panel 200, and the same polarizing plates 120 (or polarizing plates 180) are disposed on two opposite sides of the viewing angle control panel 101. It should be understood that the above-mentioned configuration of the polarizing plates 120 and 180 is applicable to all embodiments of the present disclosure and will not be repeated below. It should be understood that, in this embodiment, the half-wave plate 300 and the polarizing plates 120 and 140 are disposed between the viewing angle control panels 101 and 103 to enhance the display effect of the display device 50. In some embodiments, the polarizing plate 120 between the viewing angle control panel 101 and the half-wave plate 300 may be omitted.

As shown in FIG. 5F, the display device 60 includes a display panel 200, three viewing angle control panels 101, a viewing angle control panel 103, and an optional half-wave plate 300. It should be understood that in this embodiment, either of the half-wave plate 300 and the polarizing plates 120, 140, 160 and/or 180 are disposed between the viewing angle control panels 101 and 103 to enhance the display effect of the display device 60. In some embodiments, the polarizing plate 120 (or the polarizing plate 180) between the viewing angle control panel 101 and the half-wave plate 300 may be omitted.

In FIG. 5G, the display device 70 includes a display panel 200, two viewing angle control panels 101, a viewing angle control panel 103, and an optional half-wave plate 300. In the embodiment, the viewing angle control panels 101 are respectively disposed on opposite sides of the display panel 200, and the viewing angle control panel 103 is disposed over the viewing angle control panel 101. In some embodiments, the polarizing plate 180 between the viewing angle control panel 101 and the half-wave plate 300 may be omitted.

As shown in FIG. 5H, the display device 80 includes a display panel 200, two viewing angle control panels 101, a viewing angle control panel 103, and an optional half-wave plate 300. In the embodiment, the viewing angle control panels 101 are respectively disposed on the upper and lower sides of the viewing angle control panel 103, and the display panel 200 is disposed at the bottom of the display device 80. In some embodiments, the polarizing plate 180 (or the polarizing plate 120) between the viewing angle control panel 101 and the half-wave plate 300 may be omitted.

The display devices of the above embodiment may include multiple viewing angle control panels 101 and viewing angle control panels 103. The products of the liquid-crystal birefringence value and the liquid-crystal interlayer spacing of the viewing angle control panels 101 (or viewing angle control panels 103) in the same display device may be different from each other. The product of the liquid-crystal birefringence value and the liquid-crystal interlayer spacing of the viewing angle control panel 101 located in the upper layer (close to the display side of the display device) may be greater than the product of the liquid-crystal birefringence value and the liquid-crystal interlayer spacing of the viewing angle control panel 101 located in the lower layer (away from the display side of the display device). Similarly, the product of the liquid-crystal birefringence value and the liquid-crystal interlayer spacing of the viewing angle control panel 103 located in the upper layer (close to the display side of the display device) may be greater than the product of the liquid-crystal birefringence value and the liquid-crystal interlayer spacing of the viewing angle control panel 103 located in the lower layer (away from the display side of the display device), but not limited thereto. The above features can help the display device achieve anti-peeping effect at a small viewing angle.

As described above, the present disclosure provides various display device structures. It should be understood that the display device may include at least one viewing angle control panel 101 and at least one viewing angle control panel 103, and in all embodiments of the present disclosure, the viewing angle control panel 102 may replace the viewing angle control panel 101. In some embodiments, the half-wave plate 300 between the viewing angle control panels 101 and 103 may be omitted. In some embodiments, a polarizing plate may be selectively disposed between the viewing angle control panel 103 and the half-wave plate 300. In some embodiments, a polarizing plate may be selectively disposed between the viewing angle control panel 101 and the half-wave plate 300. In all the embodiments of the present disclosure, the polarizing plate 120 can be replaced by the polarizing plate 180, and the polarizing plate 180 can be replaced by the polarizing plate 120. In all the embodiments of the present disclosure, the polarizing plate 140 can be replaced by the polarizing plate 160, and the polarizing plate 160 can be replaced by the polarizing plate 140. It should be understood that all possible configurations of the display device consistent with the present disclosure are included in the scope of the present disclosure.

FIG. 6 shows a cross-sectional view of a display device 10 in accordance with some embodiments of the present disclosure. As shown in FIG. 6, the display device 10 includes a display panel 200, a viewing angle control panel 101, a viewing angle control panel 103 and a backlight module 400, wherein the display panel 200, the viewing angle control panel 101, and the viewing angle control panel 103 are overlapped and stacked on the backlight module 400. The viewing angle control panel 103 is disposed on the backlight module 400, the viewing angle control panel 101 is disposed on the viewing angle control panel 103, and the display panel 200 is disposed on the viewing angle control panel 101, but not limited thereto. The backlight module 400 can provide light source for the display device 10 and enable the display device 10 to display images to the user. It should be understood that the backlight module 400 of the present embodiment is illustrated as an example, and any feasible backlight module 400 structure (such as a direct-type or edge-type backlight module) is included in the scope of the present disclosure.

It should be known that those skilled in the art could arbitrarily combine/arrange these display devices without violating the teachings of the present disclosure, and these combinations and arrangements are all within the scope of the present disclosure.

As set forth above, the embodiments of the present disclosure provide a display device including a plurality of viewing angle control panels made of different liquid-crystal layers. Specifically, by disposing a plurality of viewing angle control panels made of different liquid-crystal layers, good anti-peeping effect can be achieved in a wider viewing angle range. In addition, a half-wave plate may be disposed between different types of viewing angle control panels, thereby increasing light transmittance and improving the display effect of the display device.

What is claimed is:

1. A display device, comprising:
a display panel;
a first viewing angle control panel, overlapping the display panel and comprising a first liquid-crystal layer, wherein the first liquid-crystal layer has a first liquid-crystal birefringence value and a first liquid-crystal interlayer spacing; and
a second viewing angle control panel, overlapping the display panel and the first viewing angle control panel and comprising a second liquid-crystal layer, wherein the second liquid-crystal layer has a second liquid-crystal birefringence value and a second liquid-crystal interlayer spacing;
wherein the first liquid-crystal layer is different from the second liquid-crystal layer, and a product of the first liquid-crystal birefringence and the first liquid-crystal interlayer spacing is different from a product of the second liquid-crystal birefringence and the second liquid-crystal interlayer spacing.

2. The display device as claimed in claim 1, wherein an angle difference between two alignment directions of two substrates of the first liquid-crystal layer is between 80 degrees and 100 degrees, and an angle difference between two alignment directions of two substrates of the second liquid-crystal layer is between 170 degrees and 190 degrees, wherein the product of the first liquid-crystal birefringence value and the first liquid-crystal interlayer spacing is greater than the product of the second liquid-crystal birefringence value and the second liquid-crystal interlayer spacing.

3. The display device as claimed in claim 2, wherein the first liquid-crystal interlayer spacing is greater than the second liquid-crystal interlayer spacing.

4. The display device as claimed in claim 2, wherein one of the two alignment directions of the two substrates of the first liquid-crystal layer minus 180 degrees is 135 degrees, and the other of the two alignment directions of the two substrates of the first liquid-crystal layer is 225 degrees.

5. The display device as claimed in claim 2, wherein one of the two alignment directions of the two substrates of the first liquid-crystal layer minus 180 degrees is-45 degrees, and the other of the two alignment directions of the two substrates of the first liquid-crystal layer is 45 degrees.

6. The display device as claimed in claim 2, wherein macro-axes of liquid-crystal molecules in the first liquid-crystal layer gradually rotate between the two alignment directions.

7. The display device as claimed in claim 1, further comprising:
a half-wave plate disposed between the first viewing angle control panel and the second viewing angle control panel; and
a first polarizing plate is disposed between the first viewing angle control panel and the half-wave plate, wherein the half-wave plate is disposed between the first polarizing plate and the second viewing angle control panel.

8. The display device as claimed in claim 7, further comprising:
a second polarizing plate, wherein the second viewing angle control panel is disposed between the second polarizing plate and the half-wave plate, the first polarizing plate has a first transmission axis, the second polarizing plate has a second transmission axis, and an angle difference between the first transmission axis and the second transmission axis is between 35 degrees and 55 degrees.

9. The display device as claimed in claim 1, further comprising:
a backlight module, wherein the display panel, the first viewing angle control panel, and the second viewing angle control panel are disposed on the backlight module.

10. The display device as claimed in claim 9, wherein the display panel is a non-self-luminous panel.

11. The display device as claimed in claim 1, wherein the first liquid-crystal interlayer spacing is between 4 μm and 15 μm.

12. The display device as claimed in claim 1, wherein the second liquid-crystal interlayer spacing is between 2 μm and 6.5 μm.

13. The display device as claimed in claim 1, wherein the product of the first liquid-crystal birefringence value and the first liquid-crystal interlayer spacing is between about 800 nm and about 3000 nm.

14. The display device as claimed in claim 1, wherein the product of the second liquid-crystal birefringence value and the second liquid-crystal interlayer spacing is between about 400 nm and about 1300 nm.

15. The display device as claimed in claim 1, further comprising:
two polarizing plates disposed on upper and lower sides of the first viewing angle control panel, and transmission axes of the two polarizing plates are substantially perpendicular to each other.

16. The display device as claimed in claim 1, further comprising:
two polarizing plates disposed on upper and lower sides of the second viewing angle control panel, and transmission axes of the two polarizing plates are substantially parallel to each other.

17. The display device as claimed in claim 1, further comprising:
two polarizing plates disposed on upper and lower sides of the display panel, and transmission axes of the two polarizing plates are substantially perpendicular to each other.

18. The display device as claimed in claim 1, wherein the first viewing angle control panel is a twisted nematic viewing angle control panel.

19. The display device as claimed in claim 1, wherein the second viewing angle control panel is an electrically controlled birefringence viewing angle control panel.

20. The display device as claimed in claim 1, wherein the second viewing angle control panel is a vertical alignment viewing angle control panel.
